(19) United States
(12) Patent Application Publication
(10) Pub. No.: US 2026/0178245 A1
(43) Pub. Date: Jun. 25, 2026

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventor: Shigeo Fukuoka, Kanagawa (JP)

(21) Appl. No.: 19/426,277

(22) Filed: Dec. 19, 2025

(30) Foreign Application Priority Data
Dec. 24, 2024 (JP) 2024-227641

(51) Int. Cl. G06F 3/12; B41J 2/045

(52) U.S. Cl. CPC G06F 3/121; B41J 2/0451; G06F 3/1208; G06F 3/1211; G06F 3/1219; G06F 3/1256; G06F 3/126; B41J 2/04586

(57) ABSTRACT

An embodiment is a printing apparatus having a print control unit configured to determine a printing schedule for regular printing based on print data and for inspection printing for printing a test chart and execute printing according to the printing schedule, the test chart including a preliminary ejection chart related to a change in sheet size and a different chart other than the preliminary ejection chart and a detection unit configured to detect a fault on a sheet. In a case where the detection unit detects a fault on the sheet in printing of the preliminary ejection chart, the print control unit reschedules the printing of the preliminary ejection chart. In a case where the detection unit detects a fault on the sheet in printing of the different chart, the print control unit executes printing on a subsequent sheet without rescheduling the printing of the different chart.

### BACKGROUND

### Field of the Technology

The present disclosure relates to a printing apparatus, a method for controlling the printing apparatus, and a storage medium, and relates specifically to a technique to use for an inkjet printing apparatus having a printing component as wide as a printing sheet.

### Description of the Related Art

In order for a printing apparatus to have higher productivity (printing quantity, i.e., the number of sheets printed, per unit time), the printing apparatus is required to perform continuous printing with less downtime. Also, in order to generate printed objects that customers want, a printing apparatus needs to support various types of printing sheet. Note that a "printing sheet" may be referred to simply as a "sheet" herein.

In an inkjet printing apparatus, a printing component that performs printing by ejecting ink is constituted by a printhead (or a head) and the like. In a case where the head has not ejected ink for a while, ink is volatilized and is increased in density and therefore in viscosity near ejection ports, causing ejection failure. Thus, an operation for refreshing thickened ink needs to be executed in a case of executing printing on a wide sheet after a lapse of a predefined period of time. An example of such an operation is preliminary ejection.

Methods for executing preliminary ejection include one that forcibly ejects ink from nozzles after moving the head to a position which is where ink can be ejected but different from a printing position and one that ejects ink to a printing sheet during printing without moving the head from the printing position. Japanese Patent Laid-Open No. 2007-125814 executes preliminary ejection after inserting a printing sheet for preliminary ejection.

The method that performs preliminary ejection by moving the head to a position different from the printing position involves moving the head and has a problem of lowering productivity because moving the head takes several tens of seconds. The method that performs preliminary ejection by ejecting ink to a printing sheet which is not for preliminary ejection but for regular ejection requires a short period of time for each printing sheet (several hundred milliseconds although it depends on the size) but wastes the printing sheet.

To maintain a printing apparatus not to produce defective printed objects, a chart for inspecting the status of the printing apparatus is printed during printing, the chart is read by a reading device, the read image is analyzed, and based on the analysis results, feedback on the printing apparatus is performed. For example, inspection is periodically performed, the inspection being, e.g., one for checking whether nozzles forming the head are clogged and one for checking whether the printed object has color unevenness. Such inspection is typically triggered by the total number of copies or pages printed or the total period of printing time.

Also, in order for a printed object not to have any defect, a sheet without a fault needs to be used for the printing. Thus, with commercial printers, sheets to use for printing are inspected for normalcy immediately before the printing, and upon detection of a faulty sheet, printing on that sheet is stopped, and re-printing is executed. In the stopping of printing to the faulty sheet, ink ejection to the sheet is stopped as soon as the faulty sheet is detected, in order to avoid the risk of printing failure occurring as a result of a portion where ink has been ejected coming into contact with the head for a different color, causing mixing of ink. Because commercial printers execute printing so fast that ink ejection cannot be stopped in time with software control, ink ejection is stopped with hardware control using electrical signals.

Meanwhile, upon detection of a faulty sheet, in order to preserve the page order of printed objects formed by a plurality of pages, some commercial printers stop printing not only for the sheet detected as faulty, but also for the subsequent sheets, discharge them to an error bin different from a regular output destination, and performs printing again from the sheet detected as faulty. A commercial printer is a large apparatus measuring from several meters to several tens of meters, and there is a long distance between a paper feed stage to the head. Also, the path for flipping and conveying a sheet after heating and fixation of ink in order to perform double-sided printing is long as well. Thus, upon detection of a faulty sheet, although it depends on the size of the apparatus and the size of the printing sheet, several to a dozen or so sheets may be wasted in a case where the fault is detected in front-surface printing, and several tens of sheets may be wasted in a case where the fault is detected in back-surface printing.

In order to reduce waste sheets while maintaining the productivity of the printing apparatus, in a case where a faulty sheet is detected during printing of a chart for inspecting the status of the printing apparatus, the printing is continued, and a single round of inspection is skipped after that. Because this inspection is periodically conducted, there is a low possibility of a printed object becoming faulty immediately. Thus, the above practice is performed to prioritize productivity over re-inspection involving waste sheets.

However, a problem arises in a case where a target sheet is determined as a faulty sheet in printing of a preliminary ejection chart inserted before printing a wider sheet. Specifically, in a case where printing of the chart is skipped and printing is continued as it is conventionally conducted upon detection of a fault on a sheet in printing of a chart, there is a non-negligible possibility of printing failure.

### SUMMARY

An embodiment of the present disclosure is a printing apparatus having a print control unit configured to determine a printing schedule for regular printing based on print data and for inspection printing for printing a test chart and execute printing according to the printing schedule, the test chart including a preliminary ejection chart related to a change in sheet size and a different chart other than the preliminary ejection chart and a detection unit configured to detect a fault on a sheet. In a case where the detection unit detects a fault on the sheet in execution of printing the preliminary ejection chart, the print control unit reschedules the printing of the preliminary ejection chart, and in a case where the detection unit detects a fault on the sheet in execution of printing of the different chart, the print control unit executes printing on a subsequent sheet without rescheduling the printing of the different chart.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing an overall configuration of a printing system including a printing apparatus;

FIG. 2 is a hardware block diagram of an image formation controller;

FIG. 3 is a software block diagram of the image formation controller;

FIG. 4 is a flowchart of preliminary ejection chart insertion determination processing;

FIG. 5 is a flowchart of scheduling processing;

FIG. 6 is a flowchart of printing processing;

FIG. 7 is a table showing the correspondences between a print target and a print surface;

FIGS. 8A to 8D are diagrams illustrating a case where preliminary ejection is executed in double-sided printing and a sheet on which to perform the preliminary ejection is not a faulty sheet;

FIGS. 9A to 9D are diagrams illustrating a case where preliminary ejection is executed in double-sided printing and a sheet on which to perform the preliminary ejection is a faulty sheet; and

FIGS. 10A to 10D are diagrams illustrating a case where preliminary ejection is executed in double-sided printing and a sheet on which to perform the preliminary ejection is a faulty sheet.

### DESCRIPTION OF THE EMBODIMENTS

### [First Embodiment]

### <Configuration of a Printing System>

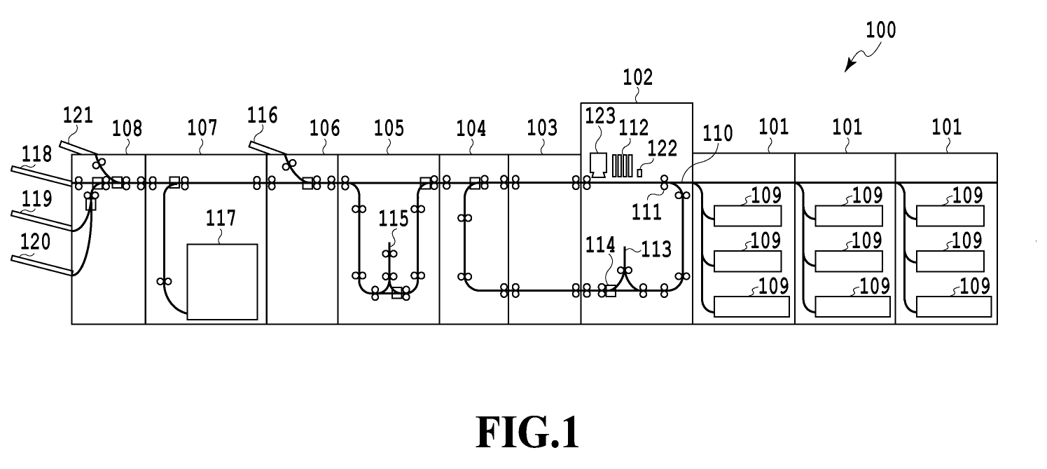

FIG. 1 is a schematic diagram showing an example overall configuration of a printing system 100 including an image formation apparatus for forming an image, i.e., a printing apparatus, in the present embodiment.

The printing system 100 has a plurality of paper feed units 101 each having a plurality of trays 109. Before starting printing processing, a user loads any of the trays 109 in the paper feed units 101 with printing sheets (hereinafter referred to simply as sheets as needed). Note that more than one tray 109 may be loaded. After the printing processing is started, a sheet type is selected as specified in a print job, and a sheet is taken from the tray loaded with the selected sheet type and is conveyed along a conveyance path 110.

A print unit 102 is configured including a printing component 112 located on a forward route (the upper part) of the conveyance path 110 and configured to print on a sheet conveyed thereto and a flipping mechanism 113 provided on a return route (the lower part) of the conveyance path 110 to flip the sheet. A plurality of rollers 111 are provided along the conveyance path 110 and rotate to move a print belt, thereby conveying a sheet. As shown in FIG. 1, each of the units such as the print unit 102 has a plurality of rollers 111 therein. A conveyance path switching point 114 includes a tab for switching the conveyance path, and in the present embodiment, the conveyance path switching point 114 is disposed at every location where the conveyance path 110 branches into two.

In a fixation unit 103, ink printed on a sheet is dried and pressurized to be fixated onto the sheet. In a diversion unit 104, in a case where double-sided printing is specified, the conveyance path for the sheet whose front surface has been printed is switched to the lower conveyance path to print its back surface. In a flip unit 105, the conveyance path is selected according to, e.g., the face up/face down printer setting included in the print job, and a printed object is conveyed accordingly. A flip path 115 is provided inside the flip unit 105, and a sheet can be flipped by going through this flip path 115. Note that a sheet can also be conveyed without going through the flip path 115, and in a case where the sheet does not go through the flip path 115 and is not flipped, the effect that the flip unit 105 gives is only a longer path to each discharge port.

In a discharge unit 106, a switch is made whether to discharge the printed object to a discharge port 116 or to pass it over to the subsequent unit. The discharge port 116 is a bin to discharge a chart inserted for inspection of the printing apparatus (called a test chart), a faulty sheet detected by a faulty sheet detection component 122 to be described later, and a printed object printed successively after the faulty sheet. A user cannot specify the discharge port 116 as a destination to discharge printed objects. In a bulk discharge unit 107, a switch is made whether to discharge the printed object to a discharge port 117 or to pass it over to the subsequent unit. In a multi-bin discharge unit 108, the printed object is sorted and discharged to any one of discharge ports 118, 119, 120, and 121 depending on the printer settings. Note that the above-described test chart in the present embodiment includes a chart for preliminary ejection and a different chart as a chart other than the chart for preliminary ejection, and this will be described in detail later.

The faulty sheet detection component 122 is disposed at a stage before the printing component 112 configured to eject ink (i.e., upstream of the printing component 112 in a sheet conveyance direction) and detects a fault on a sheet before printing. Upon detection of any fault on a sheet, the printing component 112 is notified to stop ink ejection. A faulty sheet here is one that can come into contact with the head in the printing component 112, and specific examples thereof include one with a folded edge and one in a wavy state because of a drying and fixation process performed after the front surface is printed. A printed image obtainment component 123 is disposed at a stage after the printing component 112 and configured to read various inspection charts printed by the printing component 112 and obtain chart images thus read.

### <Configuration of an Image Formation Controller>

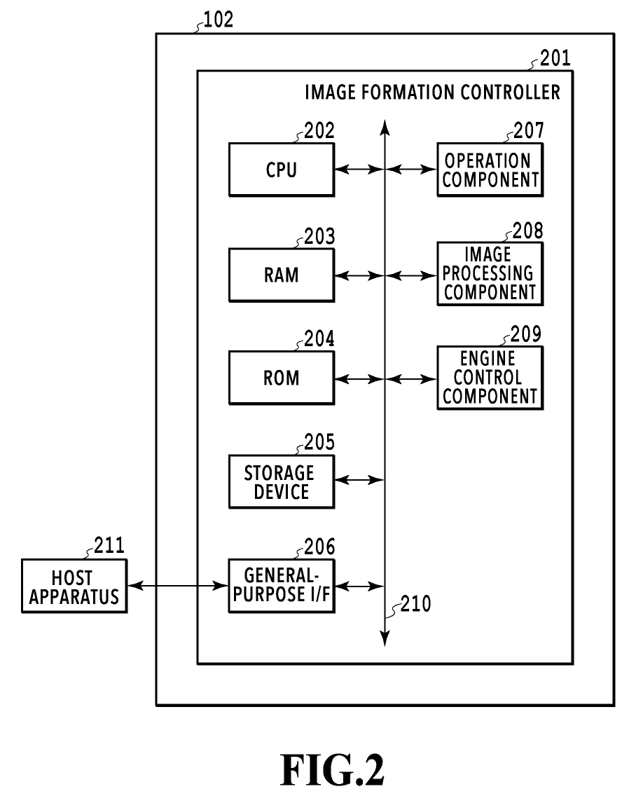

FIG. 2 is a hardware block diagram of an image formation controller 201 in the print unit 102. The image formation controller 201 has a CPU 202, random-access memory (RAM) 203, read-only memory (ROM) 204, a storage device 205, and a general-purpose interface (I/F) 206. The image formation controller 201 also has an operation component 207, an image processing component 208, and an engine control component 209. These constituents are connected to one another via a main bus 210 and can communicate (transmit and receive) information with one another. A host apparatus 211 outside the print unit 102 is connected to the image formation controller 201 via the general purpose I/F 206.

The CPU 202 is a processor that performs overall control of the components of the print unit 102. The RAM 203 functions as main memory, workspace memory, and the like for the CPU 202. A group of programs to be executed by the CPU 202 are stored in the ROM 204. Applications to be executed by the CPU 202, job information and image data used for printing, and the like are stored in the storage device 205.

The general purpose I/F 206 is Universal Serial Bus (USB), a local area network (LAN), or the like and allows, e.g., submission of a print job from the external host apparatus 211 to the print unit 102 through the general purpose I/F 206. The operation component 207 is configured including, e.g., a liquid crystal display for displaying information to a user and receiving inputs from a user. The operation component 207 communicates information related to the current status and settings to a user by displaying them on the liquid crystal display. Also, the image formation controller 201 receives a print start instruction, a print resumption instruction, and the like from a user via the operation component 207. The image processing component 208 performs printing-related control, such as print job analysis and print order determination. The engine control component 209 controls the print unit 102. Also, each of the units described above has a controller that controls the unit. This controller is formed of a CPU, RAM, a storage device, an external communication device, and the like and can communicate information with the other units and perform computation using the communicated information.

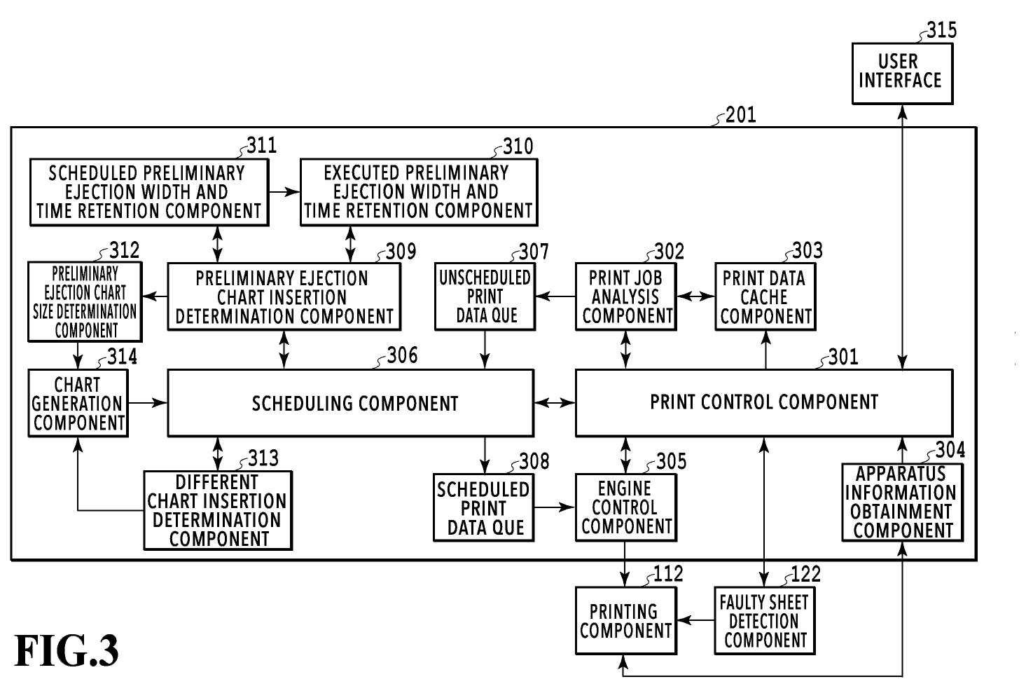

FIG. 3 is a software block diagram showing a functional configuration of the image formation controller 201. The image formation controller 201 has a print control component 301, a print job analysis component 302, a print data cache component 303, an apparatus information obtainment component 304, and an engine control component 305. The image formation controller 201 also has a scheduling component 306, an unscheduled print data queue 307, and a scheduled print data queue 308. The image formation controller 201 further has a preliminary ejection chart insertion determination component 309, an executed preliminary ejection width and time retention component 310, a scheduled preliminary ejection width and time retention component 311, a preliminary ejection chart size determination component 312, a different chart insertion determination component 313, and a chart generation component 314. A print job is submitted to the image formation controller 201 through a user interface 315, and printing is performed based on the print job submitted.

The print control component 301 generates a print instruction to the engine control component 305 based on information transmitted from the print job analysis component 302 and the apparatus information obtainment component 304. The print job analysis component 302 analyzes a submitted print job and obtains information such as the number of copies to print and the type of printing sheet as information related to the print job (referred to as job information). The print job analysis component 302 also stores print data on each printing sheet into the unscheduled print data queue 307 and into the print data cache component 303.

The apparatus information obtainment component 304 obtains information related to the printing apparatus, such as configuration information on the printing component 112 and conveyance speed. The engine control component 305, in response to a print instruction generated by the print control component 301, registers print data stored in the scheduled print data queue 308 into the printing component 112. The printing component 112 performs control to convey a sheet according to the schedule for the print data and performs control to form an image on the sheet based on the print data by ejecting ink.

The scheduling component 306 sequentially obtains print data stored in the unscheduled print data queue 307, determines a printing schedule, and then stores the sequentially-obtained print data into the scheduled print data queue 308. Note that what is meant by "scheduling" in later descriptions is to determine a printing schedule (a print order) for regular printing based on print data, inspection printing for printing a test chart described earlier, and the like. The executed preliminary ejection width and time retention component 310 retains the width and time of preliminary ejection performed last. Note that information retained in the executed preliminary ejection width and time retention component 310 is initialized at the start of printing to the width of the head and the time of uncapping the head. As information on scheduled preliminary ejection, the scheduled preliminary ejection width and time retention component 311 retains the width and scheduled time of ejection for a chart for preliminary ejection (hereinafter referred to as a preliminary ejection chart). With the configuration of the printing apparatus shown in FIG. 1, a certain period of time elapses between the scheduled time and the time of actual printing, depending on the conveyance distance and the conveyance speed. Because the next preliminary ejection may be scheduled before certain preliminary ejection is actually executed, the scheduled preliminary ejection width and time retention component 311 can retain a plurality of pieces of information on scheduled preliminary ejection.

In the event where the scheduling component 306 performs scheduling of print data, the preliminary ejection chart insertion determination component 309 refers to information retained in the executed preliminary ejection width and time retention component 310 and the scheduled preliminary ejection width and time retention component 311. Then, based on the information thus referred to, the preliminary ejection chart insertion determination component 309 determines whether a preliminary ejection chart needs to be inserted. The preliminary ejection chart size determination component 312 determines the size of sheet on which to print the preliminary ejection chart. The different chart insertion determination component 313 determines whether to insert a chart other than the preliminary ejection chart (such a chart is referred to as a different chart). Examples of the different chart is a chart for detecting print unevenness and a chart for detecting the nozzles' ejection failure such as detection of a nozzle that cannot eject ink straight due to clogging or adhesion of ink.

In response to an instruction from the preliminary ejection chart size determination component 312 or the different chart insertion determination component 313, the chart generation component 314 generates data on a preliminary ejection chart or data on a different chart and passes the generated data to the scheduling component 306. After the chart generation component 314 generates the data on the chart, the scheduling component 306 performs scheduling so that the chart will be inserted before the print data obtained from the unscheduled print data queue 307. Then, the scheduling component 306 stores the scheduled chart and print data into the scheduled print data queue 308.

In a case where the inserted chart is a preliminary ejection chart, the scheduling component 306 stores the width and scheduled time of the preliminary ejection to be executed into the scheduled preliminary ejection width and time retention component 311 via the preliminary ejection chart insertion determination component 309. Also, the scheduling component 306 schedules the print data acquired from the unscheduled print data queue 307 after the preliminary ejection chart and stores the print data into the scheduled print data queue 308.

In a case where the preliminary ejection chart is printed normally, the print control component 301 moves the information retained in the scheduled preliminary ejection width and time retention component 311 to the executed preliminary ejection width and time retention component 310 via the scheduling component 306 and the preliminary ejection chart insertion determination component 309.

Upon detection of a fault on a sheet, the faulty sheet detection component 122 notifies the printing component 112 to stop ink ejection and also notifies the print control component 301 that there is a faulty sheet. The print control component 301 performs control to continue the printing or control to discharge sheets after the faulty sheet to the discharge port 116 and re-execute the printing. The print control component 301 also performs control to delete the information retained in the scheduled preliminary ejection width and time retention component 311 via the scheduling component 306 and the preliminary ejection chart insertion determination component 309.

### <Preliminary Ejection Chart Insertion Determination Processing>

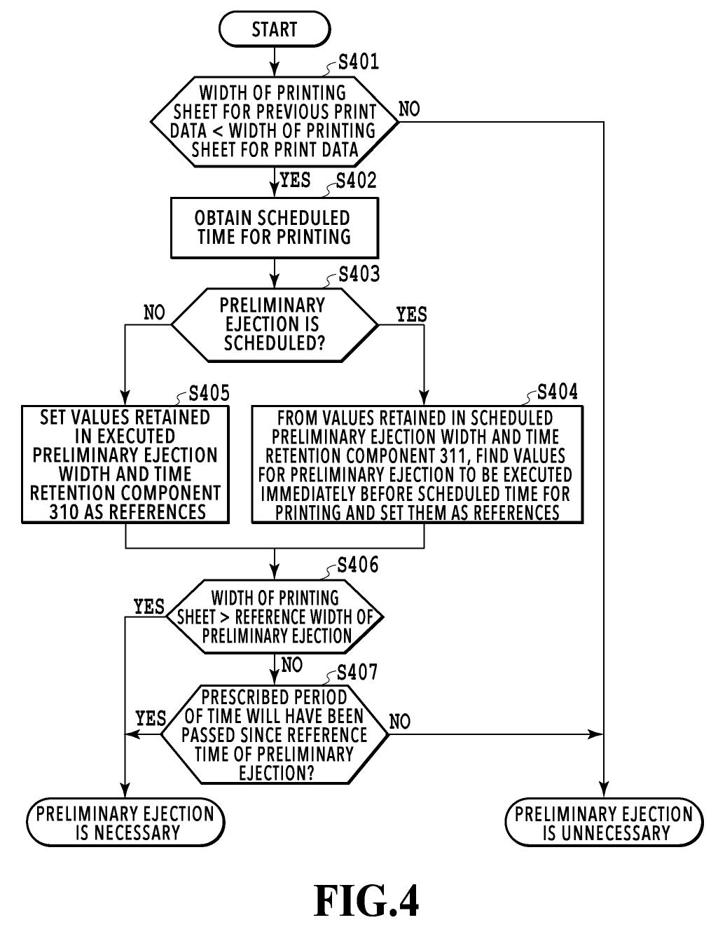

Using FIG. 4, the following describes processing to determine whether to insert a preliminary ejection chart (referred to as preliminary ejection chart insertion determination processing). The preliminary ejection chart insertion determination processing is executed by the preliminary ejection chart insertion determination component 309, the executed preliminary ejection width and time retention component 310, and the scheduled preliminary ejection width and time retention component 311.

In Step S401, the preliminary ejection chart insertion determination component 309 determines whether the width of the sheet used to print scheduled print data is larger than the width of the sheet used to print the print data immediately before the scheduled print data. If the determination result of this step is YES, the processing proceeds to S402. If, conversely, the determination result of this step is NO (i.e., if the width of the sheet used to print the scheduled print data is equal to or smaller than the width of the sheet used to print the print data immediately before the scheduled print data), it is determined that preliminary ejection is unnecessary, and the series of processes is brought to an end. Note that "Step SXXX" is abbreviated as "SXXX" hereinbelow.

In S402, the preliminary ejection chart insertion determination component 309 obtains scheduled time for printing on (or specifically ink ejection) the sheet specified in the print data scheduled in the scheduled preliminary ejection width and time retention component 311.

In S403, the preliminary ejection chart insertion determination component 309 determines whether preliminary ejection is scheduled, or specifically, whether information on the width and scheduled time of scheduled preliminary ejection is retained in the scheduled preliminary ejection width and time retention component 311. If the determination result of this step is YES, the processing proceeds to S404. If, conversely, the determination result of this step is NO, the processing proceeds to S405.

In S404, the preliminary ejection chart insertion determination component 309 sets references used for the preliminary ejection chart insertion determination. More specifically, using the scheduled time for printing obtained in S402, the preliminary ejection chart insertion determination component 309 finds the preliminary ejection to be executed immediately before the scheduled time for printing from pieces of information on scheduled preliminary ejection retained in the scheduled preliminary ejection width and time retention component 311 and sets the width and scheduled time of the thus-found preliminary ejection as the references.

In S405, the preliminary ejection chart insertion determination component 309 sets the width and time of the preliminary ejection retained in the executed preliminary ejection width and time retention component 310 as the references for the preliminary ejection chart insertion determination.

In S406, the preliminary ejection chart insertion determination component 309 determines whether the width of the printing sheet for the print data is larger than the width of the preliminary ejection set as a reference in S404 or S405. If the determination result of this step is YES, it is determined that preliminary ejection is necessary, and the series of steps is brought to an end. If, conversely, the determination result of this step is NO, the processing proceeds to S407.

In S407, the preliminary ejection chart insertion determination component 309 determines whether at the scheduled time for printing obtained in S402, a prescribed period of time or longer will have been passed since the preliminary ejection time set as a reference. If the determination result of this step is YES, it is determined that preliminary ejection is necessary, and the series of processes is brought to an end. If, conversely, the determination result of this step is NO, it is determined that preliminary ejection is unnecessary, and the series of processes is brought to an end. Note that the prescribed period of time used in this step is 120 seconds here, which is merely an example, and a different prescribed period of time may be employed instead.

### <Scheduling Processing>

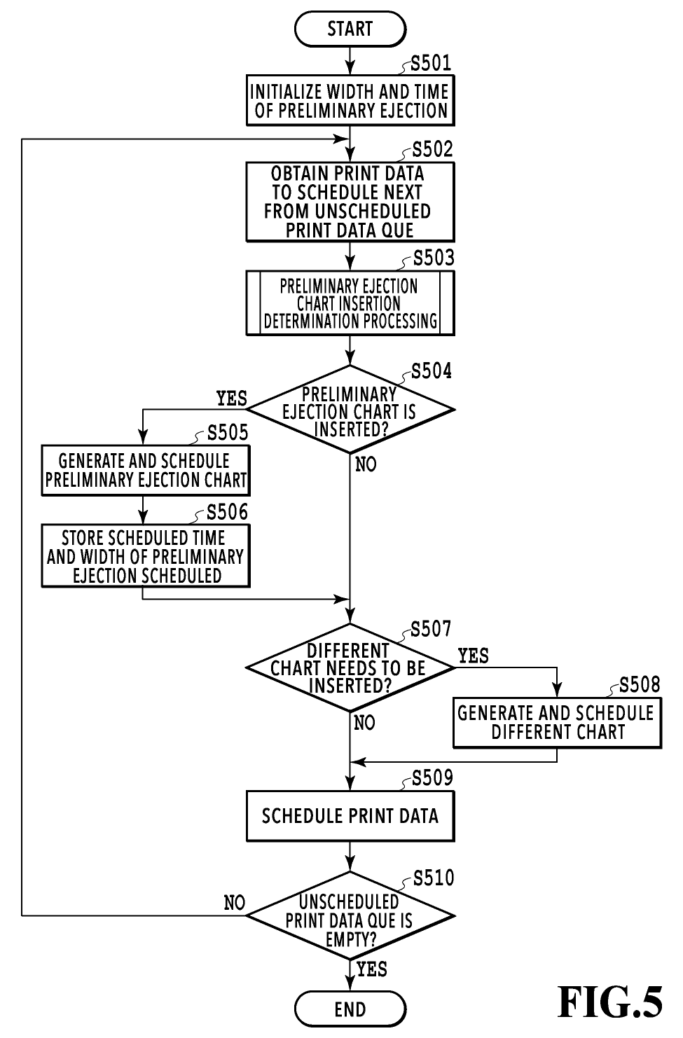

Using FIG. 5, the following describes scheduling processing to determine a printing schedule for print data and for an inserted chart in the present embodiment. The scheduling processing is executed mainly by the scheduling component 306.

In S501, the scheduling component 306 initializes information on the width and time of preliminary ejection retained in the executed preliminary ejection width and time retention component 310 at the start of printing. As a result of the initialization in this step, the time is changed to the time at which the head is uncovered at the start of printing and the width is changed to the overall width of the head.

In S502, the scheduling component 306 obtains print data to schedule next from the unscheduled print data queue 307.

In S503, the preliminary ejection chart insertion determination processing shown in FIG. 4 is executed. The preliminary ejection chart insertion determination processing is executed by the preliminary ejection chart insertion determination component 309, the executed preliminary ejection width and time retention component 310, and the scheduled preliminary ejection width and time retention component 311.

In S504, based on the result of the preliminary ejection chart insertion determination processing performed in S503, the scheduling component 306 determines whether to insert a preliminary ejection chart. If the determination result of this step is YES, the processing proceeds to S505. If, conversely, the determination result of this step is NO, the processing proceeds to S507.

In S505, the scheduling component 306 generates a preliminary ejection chart through the chart generation component 314 and schedules the chart preliminary ejection.

In S506, the scheduling component 306 causes the scheduled preliminary ejection width and time retention component 311 to retain information on the width and scheduled time of the preliminary ejection scheduled in S505.

In S507, the different chart insertion determination component 313 determines whether a different chart needs to be inserted. If the determination result of this step is YES, the processing proceeds to S508. If, conversely, the determination result of this step is NO, the processing proceeds to S509.

In S508, through the chart generation component 314, the scheduling component 306 generates and schedules a different chart determined as needing to be inserted in S507. If it is determined as a result of the steps S502 to S508 that a preliminary ejection chart and a different chart need to be inserted, preliminary ejection is executed first using a sheet with a larger width, and then the different chart is printed after that. This enables the different chart to be printed normally and therefore enables the printing apparatus to be maintained in a normal state.

In S509, the scheduling component 306 schedules the print data obtained in S502.

In S510, the scheduling component 306 determines whether the unscheduled print data queue 307 is empty. If the determination result of this step is YES, the series of processes is brought to an end, and if the determination result of this step is NO, the processing proceeds back to S502. At the end of the flowchart described in FIG. 5, all the pieces of print data have been scheduled and inputted to the scheduled print data queue 308.

### <Printing Processing>

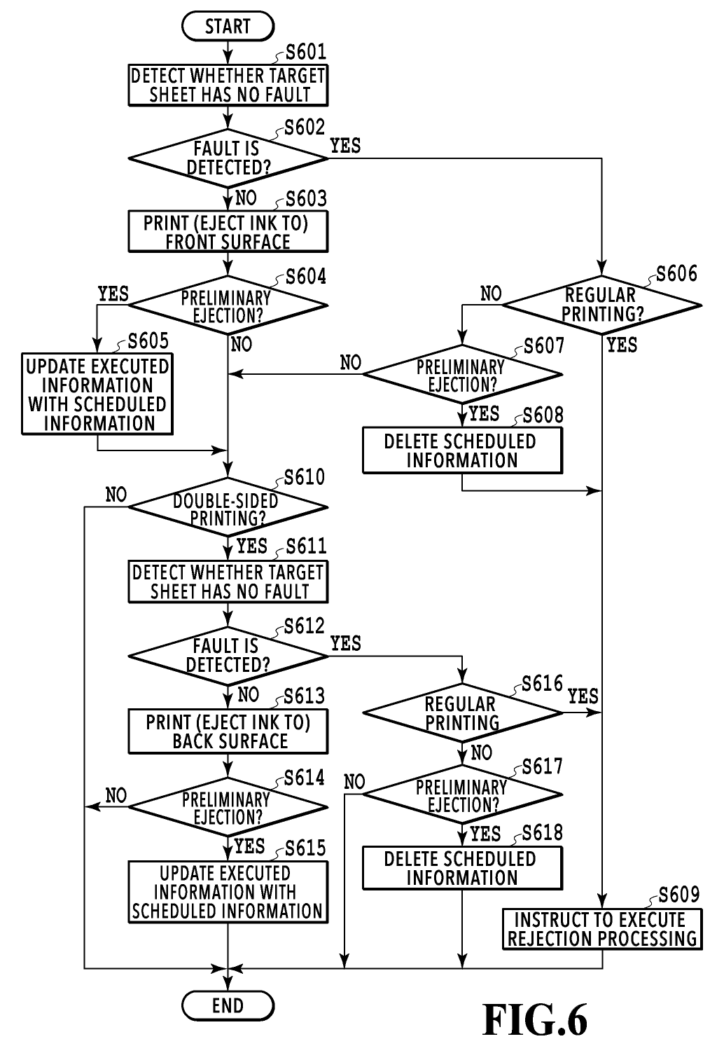

Using FIG. 6, the following describes printing processing to print print data and a chart scheduled by the scheduling processing shown in FIG. 5. FIG. 6 is a flowchart of the printing processing in the present embodiment.

In S601, using the faulty sheet detection component 122, the CPU 202 detects whether the target sheet has any fault.

In S602, the CPU 202 determines whether any fault has been detected in S601. If the determination result of this step is YES, the processing proceeds to S606. If, conversely, the determination result of this step is NO, the processing proceeds to S603.

In S603, using the printing component 112, the CPU 202 executes a printing process on the front surface of the sheet. The printing process executed in this step involves conveyance of the sheet and forms an image on the front surface of the conveyed sheet by ejecting ink.

In S604, the CPU 202 determines whether the printing on the front surface executed in S603 was for preliminary ejection. Specifically, the CPU 202 determines whether the sheet whose front surface has been printed in S603 was the first sheet after a change in sheet size, or more specifically, after a switch from a sheet with a smaller width to a sheet with a larger width. If the determination result of this step is YES, the processing proceeds to S605. If, conversely, the determination result of this step is NO, the processing proceeds to S610.

In S605, the CPU 202 updates the information retained in the executed preliminary ejection width and time retention component 310. To be more specific, the information retained in the executed preliminary ejection width and time retention component 310 is updated with the information on the width and scheduled time of the target preliminary ejection among the pieces of information retained in the scheduled preliminary ejection width and time retention component 311.

In S606, the CPU 202 determines whether the target sheet detected as faulty is for regular printing. Specifically, the CPU 202 can determine whether it is for regular printing by referring to the information retained in the scheduled preliminary ejection width and time retention component 311. If the determination result of this step is YES, the processing proceeds to S609. If, conversely, the determination result of this step is NO, the processing proceeds to S607.

In S607, the CPU 202 determines whether the target sheet detected as faulty is for preliminary ejection. The determination step executed in this step is similar to that executed in S604. If the determination result of this step is YES, the processing proceeds to S608. If, conversely, the determination result of this step is NO, the processing proceeds to S610.

In S608, the CPU 202 deletes the information on the width and scheduled time of the target preliminary ejection among the pieces of information retained in the scheduled preliminary ejection width and time retention component 311 because the preliminary ejection was not executed in the prior processing.

In S609, the CPU 202 instructs execution of rejection processing. Rejection processing is processing to change the destination to output the target sheet detected as faulty and a sheet being conveyed after the faulty sheet (i.e., a sheet already scheduled by the scheduling component) to an error bin. A bin is a part for receiving sheets printed by the printer, and an error bin is a part for receiving printing sheets detected as faulty.

In S610, the CPU 202 determines whether it is double-sided printing. Specifically, the CPU 202 can determine whether it is double-sided printing by referring to the information retained in the scheduled preliminary ejection width and time retention component 311. If the determination result of this step is YES, the processing proceeds to S611. If, conversely, the determination result of this step is NO, the printing processing on the sheet of the sheet size used is brought to an end.

In S611, using the faulty sheet detection component 122, the CPU 202 detects whether the target sheet has any fault. The detection processing executed is this step is the same as the detection processing executed in S601. While S601 is executed before the front-surface printing, this step is executed before back-surface printing.

In S612, the CPU 202 determines whether any fault has been detected in S611. If the determination result of this step is YES, the processing proceeds to S616. If, conversely, the determination result of this step is NO, the processing proceeds to S613.

In S613, using the printing component 112, the CPU 202 executes a printing process on the back surface of the sheet. The printing process executed in this step involves conveyance of the sheet and forms an image on the back surface of the conveyed sheet by ejecting ink.

In S614, the CPU 202 determines whether the printing on the back surface executed in S613 was preliminary ejection. The determination processing executed in this step is similar to that executed in S604. If the determination result of this step is YES, the processing proceeds to S615. If, conversely, the determination result of this step is NO, the processing proceeds back to S610. Note that the inserted chart is printed in single-sided or double-sided printing mode as instructed by a setting in the print job being executed in the present embodiment, and only the front surface may be printed in a case of printing a chart.

In S615, the CPU 202 updates the information retained in the executed preliminary ejection width and time retention component 310. More specifically, the information retained in the executed preliminary ejection width and time retention component 310 is updated with the information on the width and scheduled time of the target preliminary ejection among the pieces of information retained in the scheduled preliminary ejection width and time retention component 311.

In S616, the CPU 202 determines whether the target sheet detected as faulty in S611 is for regular printing. The determination processing executed in this step is similar to that executed in S606. If the determination result of this step is YES, the processing proceeds to S609. If, conversely, the determination result of this step is NO, the processing proceeds to S617.

In S617, the CPU 202 determines whether the target sheet detected as faulty in S611 is for preliminary ejection. The determination processing executed in this step is similar to that executed in S604. If the determination result of this step is YES, the processing proceeds to S618. If, conversely, the determination result of this step is NO, the printing processing is brought to an end.

In S618, the CPU 202 deletes the information on the width and scheduled time of the target preliminary ejection among the pieces of information retained in the scheduled preliminary ejection width and time retention component 311 because the preliminary ejection was not executed in the prior processing. Note that as to the process after this step, unlike the process in the case of the front surface (S608 → S609), no instruction is issued for execution of rejection processing after the deletion of the information retained in the scheduled preliminary ejection width and time retention component 311. After this step, the printing processing on the sheet of the size used is brought to an end.

Although omitted from the configuration of the present disclosure, in response to a rejection instruction for the target sheet, the sheet conveyance component outputs the target sheets to the error bin so that they will not be mixed with the normally printed ones. Also, a subsequent sheet already being conveyed is also outputted to the error bin to empty the scheduled print data queue 308. After that, print data is re-submitted from the print data cache component 303 to continue the printing.

### <Correspondences between a Print Target and a Print Surface Detected as Faulty>

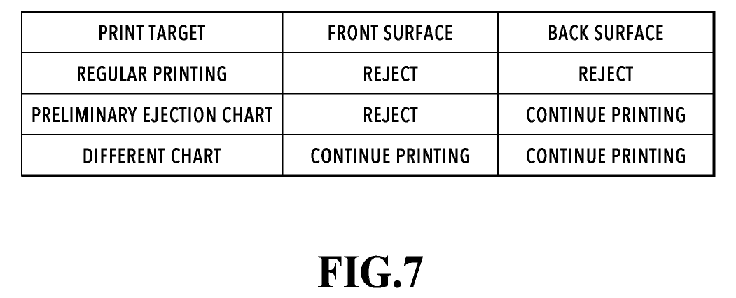

FIG. 7 shows the correspondences between a print target to be printed in the event of fault detection in the faulty sheet detection (S601, S611) in the flowchart in FIG. 6 and a print surface detected as faulty. In regular printing, the rejection processing is always executed (S606 YES → S609), and after that, reprinting is executed on a sheet that has been reloaded.

Next, a description is given of a case where the print target is a preliminary ejection chart. In this case, the rejection processing is executed in a case where a fault is detected in front-surface printing (S607 YES → ··· → S609), and a print job for a preliminary ejection chart is resubmitted. This helps prevent ink ejection failure in subsequent regular printing. By contrast, upon detection of a fault in back-surface printing, because preliminary ejection has already been executed by front-surface printing, control is performed to continue the printing without executing the rejection processing to reduce waste paper.

Next, a description is given of a case where the print target is a different chart. In this case, continuing the printing means skipping a round of inspection, but unlike regular printing and preliminary ejection, there is a low risk of immediately producing a faulty printed object. Thus, control is performed to prioritize the productivity of the printing apparatus while reducing waste paper.

### <Concrete Examples>

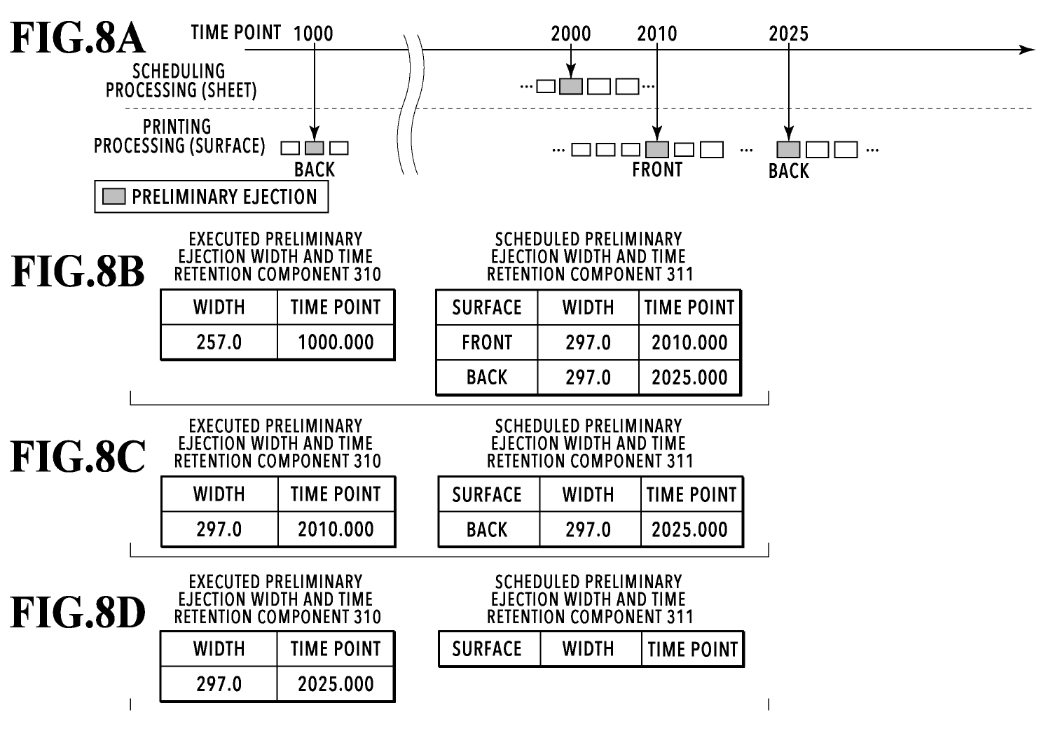

Using FIGS. 8A to 10D, the following describes concrete examples of operation performed in a case where the processing described thus far is executed by the printing apparatus in FIG. 1. In all of the cases shown in FIGS. 8A to 10D, the printing schedule is such that printing on a sheet width of 257.0 mm is followed by printing on a sheet with a sheet width of 297.0 mm.

FIGS. 8A to 8D are diagrams showing a case where preliminary ejection is to be executed in double-sided printing and is executed normally because a sheet on which to perform the preliminary ejection is not determined as a faulty sheet. FIG. 8A is a diagram showing the temporal relation between the scheduling processing described using FIG. 5 and the printing processing described using FIG. 6. Double-sided printing is performed in this case, and as shown, preliminary ejection is executed at time point 1000. Also, in scheduling of printing on the sheet with a sheet width of 297.0 mm at time point 2000, preliminary ejection is scheduled for the sheet with a sheet width 297.0 mm. Further, the sheet on which to perform the preliminary ejection is not determined as a faulty sheet, so preliminary ejection is executed on its front surface at time point 2010 and then on its back surface at time point 2025.

At the time of the scheduling of preliminary ejection at time point 2000, the executed preliminary ejection width and time retention component 310 retains the table values on the left side of FIG. 8B, and the scheduled preliminary ejection width and time retention component 311 retains the table values on the right side of FIG. 8B. At time point 2000, the new preliminary ejection has yet to be executed, and hence, the values retained in the executed preliminary ejection width and time retention component 310 remain unchanged from before.

Once the preliminary ejection is executed at time point 2010, the executed preliminary ejection width and time retention component 310 retains the table values on the left side of FIG. 8C, and the scheduled preliminary ejection width and time retention component 311 retains the table values on right side of FIG. 8C. In this way, information on the front surface is deleted from the scheduled preliminary ejection width and time retention component 311, and the information retained in the executed preliminary ejection width and time retention component 310 is updated with the information on the preliminary ejection executed on the front surface.

Once the preliminary ejection is executed on the back surface at time point 2025, the executed preliminary ejection width and time retention component 310 retains the table values on the left side of FIG. 8D, and the scheduled preliminary ejection width and time retention component 311 retains the table values on the right side of FIG. 8D. In this way, information on the back surface is deleted from the scheduled preliminary ejection width and time retention component 311, making it empty, and the information retained in the executed preliminary ejection width and time retention component 310 is updated with the information on the preliminary ejection executed on the back surface.

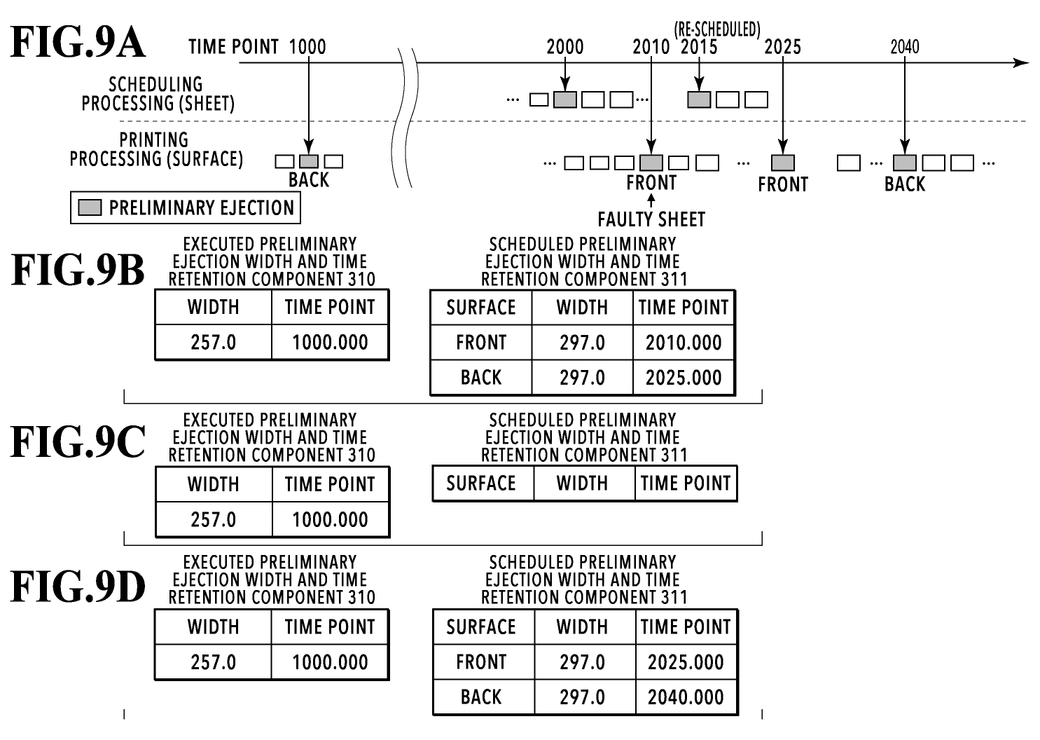

FIGS. 9A to 9D are diagrams showing a case where preliminary ejection is to be executed in double-sided printing, and a sheet on which to perform the preliminary ejection is determined as a faulty sheet in front-surface printing. FIG. 9A is a diagram showing the temporal relation between the scheduling processing described using FIG. 5 and the printing processing described using FIG. 6. Double-sided printing is performed in this case, and as shown, preliminary ejection is executed at time point 1000. Also, in scheduling of printing on the sheet with a sheet width of 297.0 mm at time point 2000, preliminary ejection is scheduled for the sheet with a sheet width 297.0 mm. Further, the sheet on which to perform preliminary ejection is determined as a faulty sheet, and rescheduling is performed at time point 2015.

At the time of the scheduling of preliminary ejection at time point 2000, the executed preliminary ejection width and time retention component 310 retains the table values on the left side of FIG. 9B, and the scheduled preliminary ejection width and time retention component 311 retains the table values on the right side of FIG. 9B. At time point 2000, the new preliminary ejection has yet to be executed, and hence, the values retained in the executed preliminary ejection width and time retention component 310 remain unchanged from before.

At the time of detection of a fault on the target sheet for the preliminary ejection to be executed at time point 2010, the executed preliminary ejection width and time retention component 310 retains the table values on the left side of FIG. 9C, and the scheduled preliminary ejection width and time retention component 311 retains the table values on right side of FIG. 9C. In this way, the information on the front surface and the information on the back surface are deleted from the scheduled preliminary ejection width and time retention component 311, making it empty. The information retained in the executed preliminary ejection width and time retention component 310 is not updated because the new preliminary ejection is not executed.

At the time of the rescheduling of the preliminary ejection at time point 2015, the executed preliminary ejection width and time retention component 310 retains the table values on the left side of FIG. 9D, and the scheduled preliminary ejection width and time retention component 311 retains the table values on the right side of FIG. 9D. At time point 2015, the new preliminary ejection has yet to be executed, and hence, the values retained in the executed preliminary ejection width and time retention component 310 remain unchanged from before. After that, preliminary ejection is executed on the front surface at time point 2025 and then on the back surface at time point 2040.

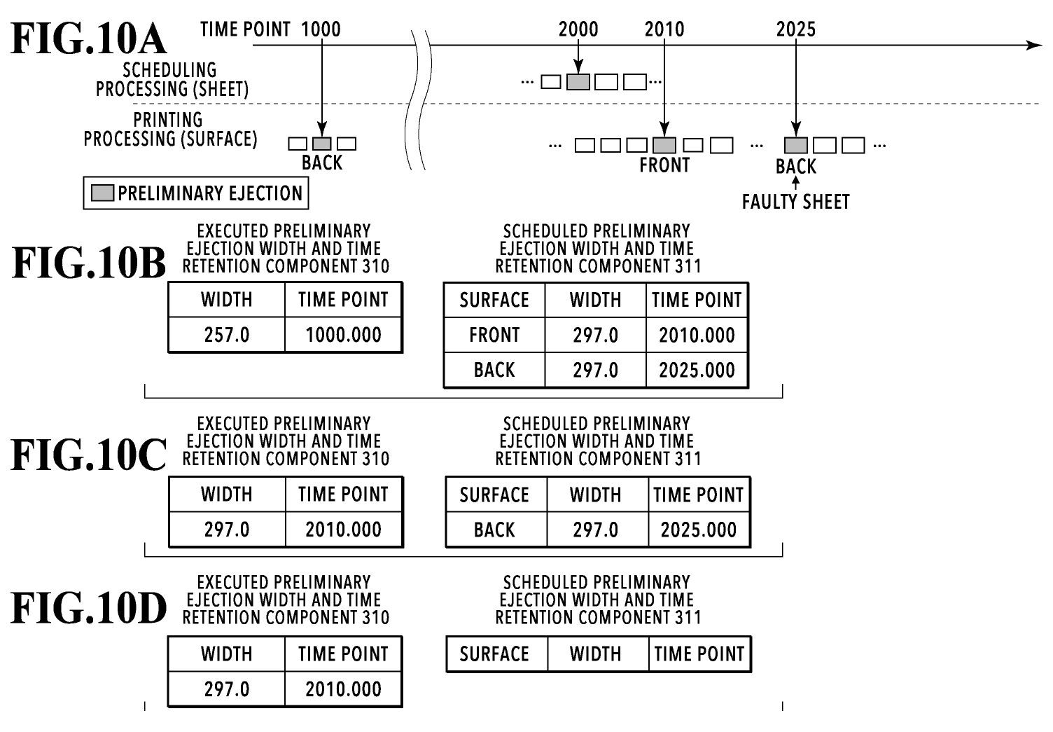

FIGS. 10A to 10D are diagrams showing a case where preliminary ejection is set to be executed in double-sided printing, and a sheet on which to perform preliminary ejection is determined as a faulty sheet before back-surface printing. FIG. 10A is a diagram showing the temporal relation between the scheduling processing described using FIG. 5 and the printing processing described using FIG. 6. Double-sided printing is performed in this case, and as shown, preliminary ejection is executed at time point 1000. Also, in scheduling of printing on the sheet with a sheet width of 297.0 mm at time point 2000, preliminary ejection is scheduled for the sheet with a sheet width 297.0 mm. Further, the sheet on which to perform the preliminary ejection is determined as a faulty sheet in back-surface printing and printing on (ink ejection to) this sheet is stopped, but the printing on the subsequent sheet is continued without rejection.

At the time of the scheduling of preliminary ejection at time point 2000, the executed preliminary ejection width and time retention component 310 retains the table values on the left side of FIG. 10B, and the scheduled preliminary ejection width and time retention component 311 retains the table values on the right side of FIG. 10B. Once the preliminary ejection is executed at time point 2010, the executed preliminary ejection width and time retention component 310 retains the table values on the left side of FIG. 10C, and the scheduled preliminary ejection width and time retention component 311 retains the table values on the right side of FIG. 10C. In this way, the information on the front surface is deleted from the scheduled preliminary ejection width and time retention component 311, and the information retained in the executed preliminary ejection width and time retention component 310 is updated with the information on the preliminary ejection executed on the front surface.

At the time of detection of a fault on the target sheet for the preliminary ejection to be executed on the back surface at time point 2025, the executed preliminary ejection width and time retention component 310 retains the table values on the left side of FIG. 10D, and the scheduled preliminary ejection width and time retention component 311 retains the table values on right side of FIG. 10D. In this way, the information on the back surface is deleted from the scheduled preliminary ejection width and time retention component 311, making it empty. Meanwhile, the information retained in the executed preliminary ejection width and time retention component 310 is not updated because the new preliminary ejection is not executed. Also, in a case where a fault is detected on the target sheet in the back-surface printing, printing is continued for the subsequent sheet, and therefore no waste paper is produced except for the sheet on which the preliminary ejection has been performed.

### [Other Embodiments]

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can reduce printing failure while maintaining the productivity of the printing apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227641, filed December 24, 2024, which is hereby incorporated by reference herein in its entirety.

What is claimed is:

1. A printing apparatus comprising:
a print control unit configured to determine a printing schedule for regular printing based on print data and for inspection printing for printing a test chart and execute printing according to the printing schedule, the test chart including a preliminary ejection chart related to a change in sheet size and a different chart other than the preliminary ejection chart; and
a detection unit configured to detect a fault on a sheet, wherein
in a case where the detection unit detects a fault on the sheet in execution of printing of the preliminary ejection chart, the print control unit reschedules the printing of the preliminary ejection chart, and
in a case where the detection unit detects the fault on the sheet in execution of printing of the different chart, the print control unit executes printing on a subsequent sheet without rescheduling the printing of the different chart.

2. The printing apparatus according to claim 1, wherein
in a case where the detection unit detects the fault on the sheet in execution of printing of the preliminary ejection chart, the print control unit instructs to execute rejection processing to change an output destination of the sheet detected as faulty and a sheet being conveyed following the sheet detected as being faulty to an error bin.

3. The printing apparatus according to claim 1, wherein
in a case where the detection unit detects a fault on the sheet in execution of printing of the preliminary ejection chart on a back surface of the sheet in double-sided printing, the print control unit does not reschedule the printing of the preliminary ejection chart.

4. The printing apparatus according to claim 3, wherein
the print control unit has a scheduling unit configured to determine the printing schedule.

5. The printing apparatus according to claim 4, wherein
the different chart includes a chart for detecting nozzle ejection failure and a chart for detecting print unevenness.

6. The printing apparatus according to claim 5, wherein
in inserting the preliminary ejection chart and the different chart, the scheduling unit performs scheduling so that the preliminary ejection chart is printed before the different chart.

7. The printing apparatus according to claim 6, further comprising a printing unit configured to form an image by ejecting ink to the sheet according to the printing schedule.

8. The printing apparatus according to claim 7, wherein
the detection unit is provided upstream of the printing unit in a sheet conveyance direction and is capable of detecting a fault on the sheet before printing.

9. The printing apparatus according to claim 8, wherein
a sheet detected as faulty by the detection unit is a sheet with a possibility of coming into contact with a head constituting the printing unit.

10. The printing apparatus according to claim 9, wherein
the sheet detected as faulty by the detection unit includes a sheet with a folded edge and a sheet in a wavy state.

11. The printing apparatus according to claim 10, further comprising a determination unit configured to make a determination as to whether to insert the preliminary ejection chart.

12. The printing apparatus according to claim 11, wherein
the determination unit makes the determination based on whether a sheet width in the print data is larger than a width of preliminary ejection set as a reference.

13. The printing apparatus according to claim 12, wherein
the determination unit makes the determination based on whether at a scheduled time for printing the print data, a prescribed period of time or longer will have been passed since a preliminary ejection time set as a reference.

14. A method for controlling a printing apparatus having
a print control unit configured to determine a printing schedule for regular printing based on print data and for inspection printing for printing a test chart and execute printing according to the printing schedule, the test chart including a preliminary ejection chart related to a change in sheet size and a different chart other than the preliminary ejection chart and
a detection unit configured to detect a fault on a sheet, the method comprising:
in a case where a fault on the sheet is detected by the detection unit in execution of printing of the preliminary ejection chart, rescheduling the printing of the preliminary ejection chart by the print control unit; and
in a case where the fault on the sheet is detected by the detection unit in execution of printing of the different chart, executing printing on a subsequent sheet without rescheduling the printing of the different chart by the print control unit.

15. A non-transitory computer readable storage medium storing a program for causing a computer to execute a method for controlling a printing apparatus having
a print control unit configured to determine a printing schedule for regular printing based on print data and for inspection printing for printing a test chart and execute printing according to the printing schedule, the test chart including a preliminary ejection chart related to a change in sheet size and a different chart other than the preliminary ejection chart and
a detection unit configured to detect a fault on a sheet, the method comprising:
in a case where a fault on the sheet is detected by the detection unit in execution of printing of the preliminary ejection chart, rescheduling the printing of the preliminary ejection chart by the print control unit; and
in a case where the fault on the sheet is detected by the detection unit in execution of printing of the different chart, executing printing on a subsequent sheet without rescheduling the printing of the different chart by the print control unit.
